(19) United States
(12) Patent Application Publication
(10) Pub. No.: US 2014/0110547 A1
(43) Pub. Date: Apr. 24, 2014

(54) ADAPTABLE BRACKET ASSEMBLY FOR PALLET RACK LOAD STOP SYSTEM

(71) Applicant: Robert M. Consaul, San Carlos, CA (US)

(72) Inventor: Robert M. Consaul, San Carlos, CA (US)

(21) Appl. No.: 13/675,346

(22) Filed: Nov. 13, 2012

Related U.S. Application Data
(60) Provisional application No. 61/717,968, filed on Oct. 24, 2012.

(51) Int. Cl. F16M 13/00

(52) U.S. Cl. CPC F16M 13/00
USPC 248/231.9; 248/205.1

(57) ABSTRACT

The new adaptable bracket enables a pallet rack stopper assembly for facilitating the positioning of a pallet onto or under a pallet rack to prevent damage to a facility caused by the pallet, itself, or by material handling equipment during the pallet positioning process, as well as to prevent general displacement of the pallet while preserving necessary space between the pallet and the facility wall, piping, doors, electrical conduit, or other items adjacent to the pallet rack. The new bracket assembly is a compact, highly adaptable, and inexpensively elegant solution to these common problems arising in storage facilities using pallet rack storage systems.

### CROSS-REFERENCE TO RELATED APPLICATIONS

This application claims the benefit of U.S. Provisional Application for Patent Ser. No. 61/717,968, filed on Oct. 24, 2012.

### BACKGROUND OF THE INVENTION

1. Field of the Invention

The new bracket assembly concerns an adaptable pallet rack stopper apparatus for facilitating positioning of a pallet on a pallet rack to prevent damage to a storage facility caused by the pallet, itself, or by material handling equipment during the pallet positioning process, as well as to prevent general displacement of the pallet while preserving necessary space between the pallet and the facility wall or other pallets.

2. Description of Related Art

Pallet racks are often used in warehouses and retail facilities for pallet material storage, and placement of pallets onto and under pallet racks is generally accomplished using a forklift or other material handling equipment such as pallet jacks. This system presents some common problems, including: 1) damage to walls, 2) interference with the minimum space required between pallet racks or between a pallet rack and wall, and 3) potential injury to persons or products from materials falling off of pallet racks. Over the past few decades, several devices have been developed to address similar issues with material storage on pallet racks, but none comprises the same features nor covers the scope of advantages afforded by the present invention.

Other systems—specifically, those described in U.S. Pat. No. 6,758,448; U.S. Pat. No. 7,059,573; U.S. Pat. No. 5,573,125; and Pub. No. U.S. 2007/0187349 A1—have been designed to prevent items from falling off shelving or rack units. The common net-and-cable design does not prevent damage to walls, maintain minimum spacing in compliance with federal or local food storage regulations stipulated by agencies, such as the USDA or county public health departments, or provide a guide for material handlers to align and place pallets, which are prime advantages of the present invention.

There are other adapter-type devices that can be used independently or in conjunction with other materials for, primarily, pallet alignment purposes. These types of devices are described in U.S. Pat. No. 4,618,064; U.S. Pat. No. 6,173,846; and Pub. No. US 2009/0084746 A1. These inventions each require some combination of drilling, mounting, installing other hardware (such as screws), and/or installing the invention during the pallet rack manufacturing process. Further, devices such as that described in U.S. Pat. No. 6,173,846 are limited to use on pallet rack shelves and cannot be used in floor-level bays. The new bracket assembly, however, adapts to pre-existing pallet rack features without having to drill holes or use additional hardware, and it can be used in both shelf- and floor-level bays. The bracket assembly converts existing pallet rack horizontal beams into load backstops by utilizing the same connection techniques that are used between pallet rack vertical and horizontal beams.

Existing devices available on the market are designed to prevent wall damage caused by pallet jacks or forklifts. Indeed, the use of backstop support bars for shelving units is known in the art, and such supports for pallet racks are usually referred to as “load stops.” These load stops are one-piece metal beams that connect the upright (vertical) beams of a pallet rack. The standard load stop design does not universally fit onto pallet racks and, therefore, must be special-ordered according to the pallet rack bay size and desired clearance. As a result, the load stops can be very costly to purchase, and production and delivery time can be quite prohibitive. The new, adaptable bracket assembly provides a ready means of inexpensive protection for warehouses and retail locations using pallet rack storage systems.

### SUMMARY OF THE INVENTION

### Introduction to the Invention.

The general purpose of the new bracket assembly is to provide an adaptable pallet rack bumper system wherein a novel bracket combines with existing beams to easily create a load stop for use on all storage levels of pallet racks, including at floor-level. The pallet rack bracket assembly is an adapter bracket made of welded steel with lock-in-place connector pins or bolt outlets similar to the pins and outlets engineered onto existing pallet rack vertical and horizontal beams. The invention depicted herewith is a simple connection bracket used in conjunction with standard horizontal beams to stop material handlers from accidentally placing product too far into pallet rack bays, thereby causing damage to walls, product, or other storage materials common in warehouse settings.

This new adapter allows for universal use with a variety of pallet rack styles found in hundreds of thousands of existing warehouse facilities. The new adapter presents to manufacturers of pallet racks a low-cost alternative to creating the one-piece pallet rack load stop bars on the market today, as it can be fabricated by repurposing leftover vertical pallet rack beams. Further, the new adapter is compact and easy to stock in supply houses making it readily available for customer acquisition, unlike standard load stops, which must be custom-made.

The bracket assembly for pallet rack load stops is designed to connect to pallet rack upright beams via the same mechanisms as existing pre-engineered horizontal beams, thus making the device highly adaptable and easy to use with existing materials. Since pallet racks can be engineered with different compositions and thicknesses of metal and any of several different types of connectors, the new adaptable bracket assembly can be engineered to compliment any type of pallet rack system.

### 2. Objectives of the Invention.

It is an objective of the new bracket assembly to provide a novel, adaptable bracket assembly for a pallet rack that delivers many of the advantages of the relevant prior art with the additional benefit of preventing damage to warehouse or retail facility walls, doors, piping, electrical conduit, or other items found adjacent to pallet racks.

It is another objective of the new bracket assembly to provide a new bracket assembly for consistent, effortless maintenance of requisite space between pallets and walls for rodent traps in storage facilities of food suppliers as required by federal or local food storage regulations.

Yet another objective of the new bracket assembly is to provide a new bracket assembly that connects to pallet racks in the same manner that existing pre-engineered horizontal beams connect to pallet rack vertical beams. Such horizontal beams are generally readily available and are far less expensive than the common one-piece custom-order alternative.

The sum of these objectives—including associated advantages—unifies with the novel article of the new bracket assembly, resulting in an invention that is not anticipated, rendered obvious, suggested, or even implied by any of the prior art support, either alone or in any combination thereof.

These, together with other objects of the invention, along with the various features of novelty characterizing the invention, are described with particularity in the claims herewith. A more comprehensive understanding of the features, operation and uses of the invention may be gleaned from reference to the enclosed drawings and descriptive matter further illustrating the preferred embodiments of the invention.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

Clearly related figures have the same title number with sequential alphabetic suffixes.

FIGS. 1A-1F show, respectively, top-side-front, top-side-back, front, back, top and bottom views of the standard model pallet rack bracket assembly.

FIGS. 2A-2B show, respectively, the top-side-front and top-side-back views of the alternative “light duty” embodiment of the bracket assembly.

FIGS. 3A-3B illustrate another alternative embodiment of the bracket assembly. FIG. 3A shows the side view of the 3″ and 6″ standard bracket assembly units unconnected, and FIG. 3B shows the side view of the 3″ and 6″ standard bracket assembly units attached to one another and to the existing pallet rack upright beam.

FIG. 4 shows a three-dimensional top-side-back view of the stacked 3″ standard bracket assembly unit connected by its front end to an existing pallet rack upright beam and connected by its back end to the front end of a 6″ standard bracket assembly unit, which is attached by its back end to an existing horizontal beam.

### DESCRIPTION OF THE INVENTION

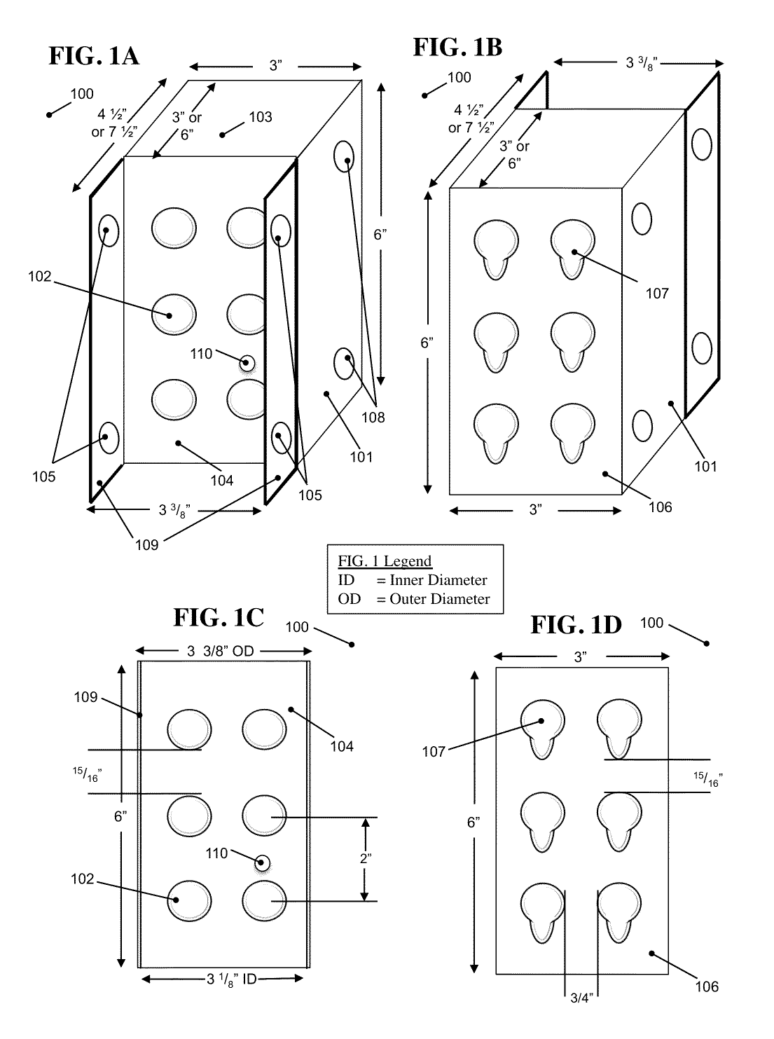

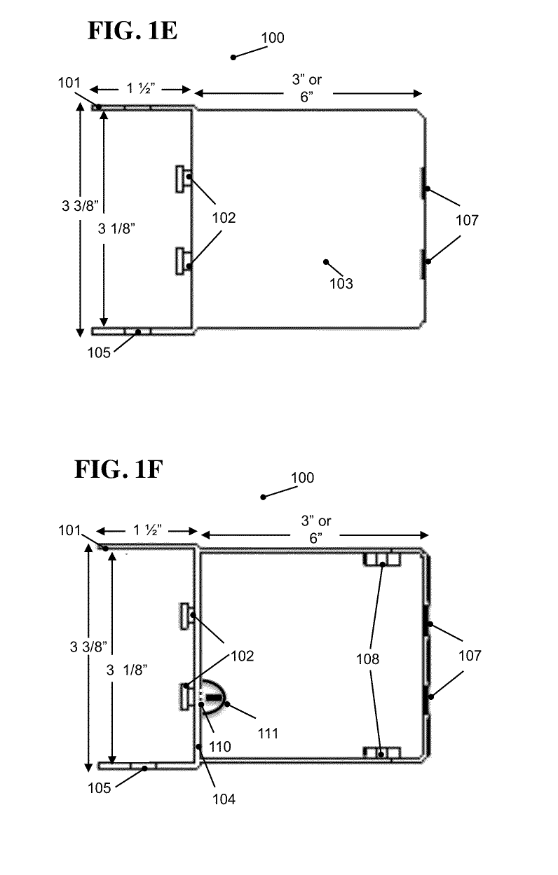

### 1. FIGS. 1A-1F

### First Embodiment

FIGS. 1A-1F collectively illustrate one embodiment of the bracket assembly wherein the length of the bracket assembly body is variable, it has optional flanges for added strength, and the unit is stackable (hereafter the “standard model”). In this embodiment, the bracket is generally rectangular.

FIG. 1A shows the top-side-front view of the standard model 100. In one embodiment, the front plate 104 is 6″ high and 3″ wide and is embellished with six male teardrop connectors 102 and a locking pin hole 110. In another embodiment—what can be called a “heavy duty” model—the front plate 104 is 7½″ high and 3″ wide and is embellished with eight male teardrop connectors. The number, shape, arrangement of connectors, and locking pin hole depicted here match the number, shape, arrangement of connectors, and locking pin hole of the common upright-horizontal beam system in pallet rack and load stop manufacturing, but the number, shape, arrangement of connectors, and locking pin hole can vary depending on the type of pallet rack and purpose of the load stop. The side plates 101 are 6″ high and can vary in length, but the commonly used lengths are 3″ and 6″. The front plate 104 is attached perpendicularly by its long edges to the side plates 101 flush with the top and bottom. In one embodiment, 1½″ deep “flanges” 109 attach perpendicularly to the vertical edges of the front plate. There is a pair of ⅜″ mounting holes 105 placed through the flanges 109 for extra support if needed for stacking two units together or for connecting to an upright or horizontal beam. There is an additional pair of ⅜″ threaded mounting holes 108 placed through the near-top-back and near-bottom-back corners of the side plates 101 for extra support for stacking two units together or bolting a horizontal beam, if needed. A locking clip pin penetrates from the back of the front plate 104 through the locking pin hole 110. There is a top plate 103 that is welded on its four sides flush to the top edges of the front 104, back 106 and side 101 plates.

This bracket assembly model can be used by itself or, in an alternative embodiment, stacked with another unit to achieve desired clearance for the load stop. The front end 104 connects to the existing pallet rack upright in the same manner as an existing pallet rack horizontal beam. Alternatively, the front end 104 can be connected (or “piggybacked”) to the back end 106 of a second bracket assembly unit 100 for added clearance. In this embodiment, bracket assembly units can clip together via the teardrop connectors and locking pin. It can be further secured by bolting the units together using the ⅜″ holes 105 in the flanges 109 of one bracket assembly unit and the ⅜″ threaded holes 108 in the side plates of a second unit.

FIG. 1B shows the top-side-back view of the stackable model 100. In one embodiment, the back plate 106 is 6″ high and 3″ wide and has six female teardrop connectors 107. In another embodiment—the heavy duty model—the back plate 106 is 7½″ high and 3″ wide and has eight female teardrop connectors. As described above, the number, shape, and arrangement of the connectors is variable and should be selected to compliment the pallet rack system in which the bracket assembly will be used. The back plate 106 is attached perpendicularly by its long edges to the side plates 101 flush with the top corner, bottom corner and long edge. The pallet rack horizontal beam connects to the back end of the bracket assembly. This combination of horizontal beam connected to the bracket assembly creates a load stop that can be placed at any desired height on a pallet rack upright beam.

FIG. 1C shows the front view of the standard model 100. This view shows the front plate 104 connected perpendicularly on its edges to the flanges 109 of the side plates 101, having an inner horizontal dimension of 3⅛″ and an outer horizontal dimension of 3⅜″. The male teardrop connectors 102 are spaced vertically 2″ from the connector centers, and the minimum vertical spacing is 15/16″. The locking pin hole 110 is 5/16″ in diameter and is 1/16″ above a male connector. The male teardrop connectors and locking pin hole are set in the same configuration as necessary for connecting to an existing pallet rack vertical beam.

FIG. 1D shows the back view of the standard model 100. This view shows the back plate 106 having six female teardrop connectors 107. The female teardrop connectors 107 have minimum vertical spacing of 15/16″ and minimum horizontal spacing of ¾″. The female teardrop connectors are set in the same configuration as necessary for connecting to an existing horizontal beam.

FIG. 1E shows the top view of the standard model 100. In one embodiment, the top plate 103 covers the inside of the unit, keeping it clean from dust and debris.

FIG. 1F shows the bottom view of the standard model 100. A locking pin clip 111 is attached to the back of the front plate 104. In use, the locking pin is manually inserted into the locking pin hole 110 by pressing on a clip that pushes the pin through the hole. The pin then connects to the residual space inside a female teardrop connector while the corresponding male teardrop connectors of a standard or piggybacked bracket are in place. The locking pin clip 111 locks the units together by restricting movement and, thus, preventing inadvertent lift and extraction from the connected position. The use of such clips is not restricted to teardrop connectors but, rather, is adaptable to any type of connector used in pallet rack systems (e.g., slotted, speedrack, interlake, old style teardrop, keystone, sturdibilt, T-bolt, slide-and-lock, lynx, structural and teardrop).

The top of the bracket assembly can be open or solid. Having a solid top does not increase the strength because the bracket assembly is meant to be a connection bracket between a pallet rack upright and an existing horizontal beam to create a load stop. The solid top, however, keeps the inside of the bracket assembly clean from dust and debris, which is particularly important when used on pallet racks in storage facilities that house consumable products such as produce or other food-based products.

The front flanges can be comprised of repurposed male teardrop connection plates, locking pin clip, and locking pin hole that are pre-engineered for horizontal beams. Or, the flanges can be welded onto both sides of the front plate to align the bracket assembly when connecting to an upright beam or when piggybacking to another adapter unit. 1½″-deep flanges are depicted, but the precise depth is not critical to the function of the flanges. The back plate is derived from existing upright pallet rack beams that are pre-engineered with female teardrop connectors. The bracket assembly can be fabricated with other materials but it is less costly to repurpose materials used to make pallet rack horizontal and upright beams with only a few necessary modifications.

In use, one snaps the front plate of the bracket assembly onto an existing pallet rack upright via insertion of male connectors into the female connectors of the upright at the desired height, then locking them in place with the locking pin just as one would attach a horizontal beam to a pallet rack upright beam. Then, an existing horizontal beam having male connectors can be attached to the back plate of the bracket assembly by inserting the male connectors of the beam into the female connectors of the bracket assembly. The result is a height-adjustable, strong bumper that keeps material handlers from placing pallets beyond the perimeter of the pallet rack bay.

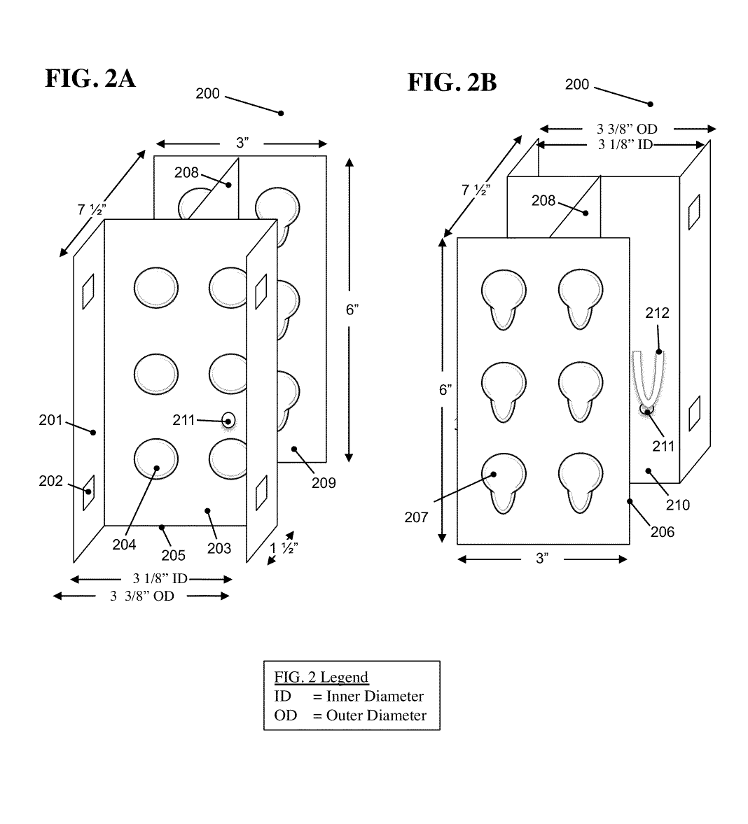

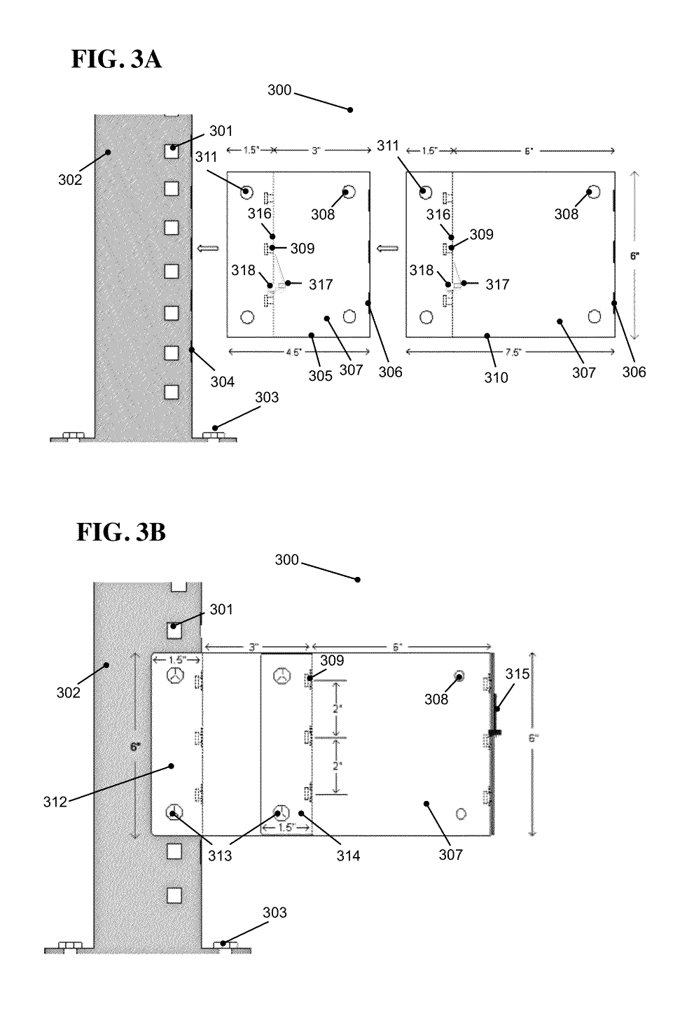

### 2. FIGS. 2A, 2B, 3A, 3B

### Additional Embodiments

FIG. 2. FIG. 2A-B illustrates one embodiment 200 of the bracket assembly wherein the length of the bracket assembly is 7½″, including 1½″-deep flanges 201 and a 6″ long body plate 208. The unit appears as an I-shape with flanges (hereafter “light duty model”). Note that 1½″-deep flanges are depicted, but the precise depth is not critical to the function of the flanges.

FIG. 2A shows the top-side-front view of the light duty model 200, where the front plate 205 is embellished on its front side 203 with six male teardrop connectors 204 and is connected on the front long edges to two 1½″ deep flanges 201 containing two side mounting holes 202 for extra support as needed. The backside of the front plate 210 connects from its vertical center axis to the vertical center axis of the backside of the back plate 209 via the body plate 208. The bracket assembly connects via the front end 205 to the existing pallet rack upright in the same manner as an existing pallet rack horizontal beam. The bracket assembly can be further secured to an upright beam or a standard bracket assembly by insertion of a locking pin 212 through a hole 211 in the front plate 210 located just above a male connector 204.

FIG. 2B shows the top-side-bottom view of the light duty model 200, where the back plate 206 contains six female teardrop connector holes 207 and is connected from the vertical center axis of its back side 209 to the back side of the front plate 210 via the body plate 208. The bracket assembly connects via the back end plate 206 to a pallet rack horizontal beam, thus creating a “load stop.” The light duty model cannot piggyback to other bracket assembly units like the heavy duty model.

In use, the light duty model is attached to the upright and horizontal beams in the same manner as the standard model 100. Like the standard model, the light duty model can be piggybacked onto a standard model bracket, but it cannot have any other bracket piggybacked onto it (i.e., the front end of the light duty model can connect to the back end of the standard model, but the back end of the light duty model can only be connected to a horizontal beam). The other key difference is that the light duty model is potentially weaker against horizontal stress, as the end connector plates are supported by only one body plate whereas the standard model has two body plates, which provides extra support.

FIGS. 3A-3B illustrate, respectively, the side view of 3″ and 6″ stackable bracket assembly units 300 unconnected and side view of 3″ and 6″ stackable bracket assembly units attached to one another and to a pallet rack upright beam. This is a view of the 3″ and 6″ bracket assemblies piggybacked for a total clearance of 9″, but any combination of sizes can be used to achieve the desired clearance between the back of the existing pallet rack upright beam and the front of the existing horizontal beam, which is now being used as a load stop beam.

FIG. 3A shows the side view of the 6″ standard bracket assembly 310 and 3″ standard bracket assembly 305 in proximity to an existing pallet rack upright beam 302. In this embodiment, there is a hole 316 above one male teardrop connector on the front pates of each bracket assembly through which a locking pin 317 located on the backside of each front plate can be inserted into the remaining space of the corresponding female connector once each bracket is connected to a vertical beam or to another bracket assembly.

FIG. 3B shows the side view of the 6″ standard model 310 connected to the 3″ standard model 305, which is connected to an existing pallet rack upright beam 302. Here, the male connectors located on the attachment flange of a horizontal pallet rack beam 315 are locked into the female connectors 306 on the back end plate of a 6″ unit 310. The male connectors 309 on the front plate 316 and locking pin clip 318 on the back side of the front plate 316 using the locking pin hole 317 of the 6″ unit are locked into the female connectors 306 on the back end plate of the 3″ unit, and bolts 313 are threaded through both the mounting holes 311 in the flanges 314 of the 6″ unit and the mounting holes 308 of the side plates 307 to further secure attachment of the piggybacked units. Likewise, the male connectors 309 on the front plate 316 and locking pin clip 318 of the 3″ unit are locked into the female connectors 304 on the upright beam 302, and bolts 313 are threaded through both the mounting holes 311 in the flanges 312 of the 3″ unit and the mounting holes 301 located on the sides of the upright beam to further secure attachment of the unit to the pallet rack, which is secured to the floor by bolts 303.

The new pallet rack bracket assembly adapter can be used by itself or together with another unit to obtain the desired clearance by using any combination of sizes from 1.5″ to 12″. A bracket assembly can be clipped to an existing pallet rack upright beam or can be piggybacked to another stackable unit. Once the connector brackets are in place they can be bolted together for extra support.

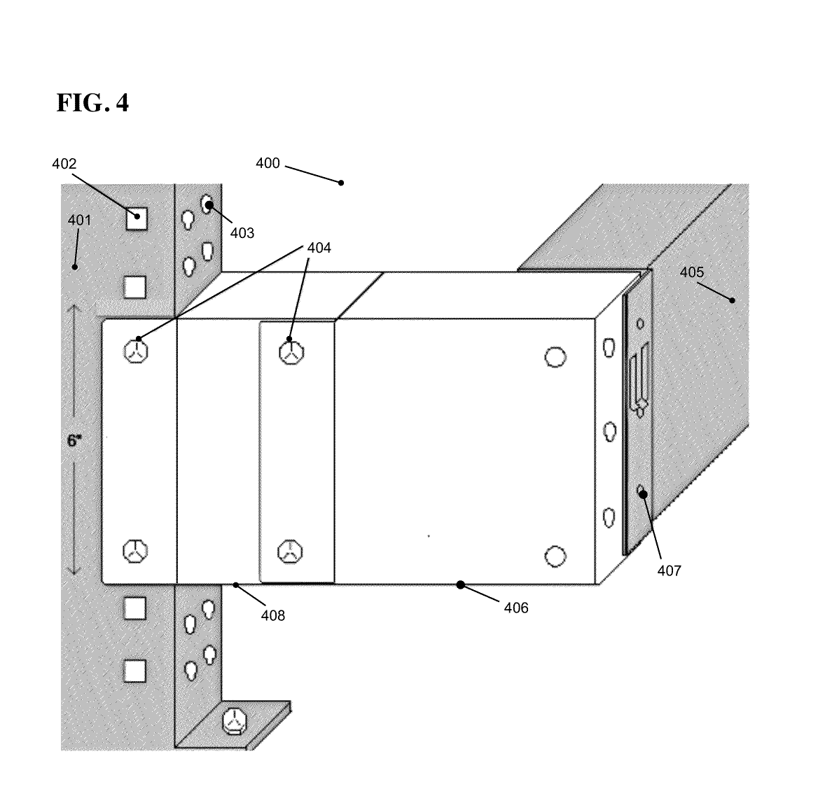

### 3. FIG. 4

### Alternate View of Stackable Brackets in Use

FIG. 4 shows a three-dimensional top-side-back view 400 of a 3″ standard bracket assembly unit 408 connected at the front end to an existing pallet rack upright beam 401 and connected at the back end to the front end of a 6″ standard bracket assembly unit 406, which is attached at the back end 407 to a horizontal pallet rack beam 405. The 3″ bracket assembly is secured to the vertical pallet rack beam via insertion of the male teardrop connectors on the front side of the 3″ bracket assembly into the female teardrop connectors 403 on the vertical beam and is further secured by bolts inserted through the pair of holes in the flanges of the 3″ bracket assembly and through the corresponding pair of holes 402 in the sides of the vertical pallet rack beam. The 6″ bracket assembly is further secured to the 3″ bracket assembly by bolts 404 inserted through the pair of holes in the flanges of the 6″ bracket assembly and screwed into the corresponding pair of threaded holes in the side panels of the 3″ bracket assembly.

As to further discussion of the manner of usage and operation of the present invention, the same should be apparent from the above description. With respect to the above description then, it is to be realized that the optimum dimensional relationships for the parts of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention, the use of which results in a bumper system that:
keeps material handlers from placing product beyond the perimeter of the pallet rack bay, which can result in damaged walls or product;
makes it easier for material handlers to accurately place pallets inside pallet rack bays or on the floor beneath pallet rack shelves because the bumper provides a guide to assist them with properly aligning pallets; and
prevents pallets from being placed too close to walls in violation of federal and/or local health code regulations. For example, that a 12-inch gap exist between the back side of a pallet of food items and the proximal wall or other stored product to maintain clearance sufficient to accommodate rodent traps.

Although the description presented heretofore contains specificities for the benefit of illustration, these should not be construed as limiting the scope of the embodiments but rather as illustrative examples of some of the several embodiments. For example, bracket assemblies may primarily be made from 16 gauge steel since most existing pre-engineered standard duty pallet rack uprights are made of 16 gauge steel. There exist, however, other pre-engineered heavy duty and light duty pallet rack uprights and horizontal beams that are made of a thicker or lighter gauge depending on the required support. Bracket assembly load stop adapters can and should be made from steel of a gauge thickness and connection type complimentary to that used in the uprights and horizontal beams with which the bracket assembly will be utilized. Thus, the scope of the embodiments should be determined by the appended claims and their legal equivalents rather than by the examples provided.

REFERENCE NUMBERS

100: Stackable bracket model
101: Side plate
102: Male teardrop connectors
103: Top plate
104: Front plate
105: Mounting holes (flanges)
106: Back plate
107: Female teardrop connectors
108: ⅜″ bolt through threaded holes
109: Side flanges
110: Locking pin hole (front plate)
111: Locking pin clip (back of front plate)
200: Light duty (T-U) bracket model
201: Side flanges
202: Side mounting hole
203: Front plate, front side
204: Male teardrop connectors
205: Front plate
206: Back plate
207: Female teardrop connectors
208: Body plate
209: Back plate, back side
210: Front plate, back side
211: Locking pin hole
212: Locking pin clip
300: 3″ and 6″ stackable units
301: Upright beam mounting holes
302: Pallet rack upright beam
303: Bolt, bolting beam to floor
304: Female teardrop connectors on upright
305: 3″ stackable bracket
306: Female teardrop connectors
307: Side plate
308: Threaded mounting holes
309: Male teardrop connectors
310: 6″ stackable bracket
311: Mounting holes
312: Side flange extending over upright
313: Bolts, connecting the brackets
314: Side flange extending over second bracket
315: Horizontal beam flange
316: Front plate
317: Locking pin hole
318: Locking pin clip
400: 3″ and 6″ piggybacked brackets
401: Existing pallet rack upright
402: Mounting holes for ⅜″ bolt in upright
403: Female teardrop mounting holes
404: 3/8″ bolts connecting 3″ and 6″ units
405: Existing horizontal beam
406: 6″ stackable bracket assembly unit
407: Back end of a 6″ stackable bracket
408: 3″ stackable bracket assembly unit

What is claimed is:

1. An adaptable bracket assembly for a pallet rack, comprising:
first end means having a plurality of connection members of a suitable quantity, shape and arrangement for attachment to a vertical pallet rack beam;
second end means having a plurality of connection members of such quantity, shape and arrangement as suitable for attachment to a horizontal pallet rack beam;
support means for connecting said first and second end means, orienting said first and second end means such that the first end means attaches to the second end means and where each of two opposing sides of the support means is secured at an angle generally perpendicular to each of the said first and second end means.

2. An adaptable bracket assembly for a pallet rack as described in claim 1, wherein the support means is a single metal piece attaching the first and second end means and wherein the bracket assembly is, generally, I-shaped.

3. An adaptable bracket assembly for a pallet rack as described in claim 1, wherein the support means is a plurality of metal pieces attaching the first and second end means, making the bracket assembly, generally, rectangular.

4. An adaptable bracket assembly for a pallet rack as described in claim 3, wherein each support means contains one or more holes enabling insertion of a locking means, such as a bolt.

5. An adaptable bracket assembly for a pallet rack as described in claim 1, wherein the connection members of the first end means are pallet rack connection members of a style chosen from the group comprising slotted, speedrack, interlake, old style teardrop, keystone, sturdibilt, T-bolt, slide-and-lock, lynx, structural and teardrop.

6. An adaptable bracket assembly for a pallet rack as described in claim 1, wherein the connection members of the second end means are pallet rack connection members of a style chosen from the group comprising slotted, speedrack, interlake, old style teardrop, keystone, sturdibilt, T-bolt, slide-and-lock, lynx, structural and teardrop.

7. An adaptable bracket assembly for a pallet rack as described in claim 1, further comprising a metal top piece or a bottom piece welded on at least two sides to the top edges of the end means or support means.

8. An adaptable bracket assembly for a pallet rack as described in claim 1, further comprising one or more extension means, wherein an edge of each extension means is welded at an angle generally perpendicular to a vertical edge of the first end means, thereby creating one or more flange(s) for facilitating guidance in connecting a bracket assembly to a vertical pallet rack beam.

9. The extension means of claim 8 comprising a plurality of attachment points for further securing bracket assembly to a vertical pallet rack beam.

10. An adaptable bracket assembly for a pallet rack as described in claim 1, further comprising a locking means.

11. The locking means of claim 10, wherein said locking means comprises a hole in the first end means enabling employment of said locking means and an insertion means positioned on the back, non-connector side of the first end means of a shape and size such that it can be inserted into the open space of a female connection member of a vertical pallet rack beam or other bracket assembly while a corresponding male connection member of an attached vertical beam or other bracket assembly is in proper position, whereby said locking means restricts mobility of the male connection members of the attached bracket assembly inside the female connection members of the vertical beam and, thus, prevents unintended dissociation of the bracket assembly from the vertical pallet rack beam.

12. An adaptable bracket assembly for a pallet rack as described in claim 1, wherein the support means comprises a plurality of overlapping or nesting members having a locking means such that the total length of the support means can be adjusted by disengaging the locking means, overlapping or nesting the members of the support means more or less, and reengaging the locking means, thus changing the clearance between the first and second end means.
